(19) United States
(12) Patent Application Publication
(10) Pub. No.: US 2004/0049403 A1
(43) Pub. Date: Mar. 11, 2004

(54) Methods and systems for dispute management

(76) Inventors: Dietmar Engelmann, Sinsheim (DE); Philipp Kehrer, Heidelberg (DE); Martin Molz, Wiesloch (DE); Dirk Scheller, Walldorf (DE); Volker Schnuck, Munster (DE); Stephan Wilhelm, Dielheim (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/456,260

(22) Filed: Jun. 5, 2003

Related U.S. Application Data
(60) Provisional application No. 60/386,642, filed on Jun. 5, 2002.
(60) Provisional application No. 60/401,777, filed on Aug. 8, 2002.

(51) Int. Cl. G06F 17/60

(52) U.S. Cl. 705/1

(57) ABSTRACT

The present invention provides methods and systems for resolving disputes that arise when a party to a transaction does not fulfill one or more obligations related to the transaction according to the terms of a related agreement or contract. Business transactions may be stored electronically and the failure of any party to fulfill obligations related to the business transaction may be electronically identified or information relating to a dispute may be manually entered. A data object comprising information relating to the business transaction and the dispute is generated and transmitted to a dispute resolution entity. Data needed for resolving the dispute may be automatically collected and dispute resolution actions may be automatically determined and initiated.

### RELATED APPLICATIONS

This application claims the benefit of priority of Provisional Application No. 60/386,642, filed Jun. 5, 2002, and Provisional Application No. 60/401,777, filed Aug. 8, 2002, both of which are incorporated herein by reference.

### FIELD OF THE INVENTION

This invention generally relates to methods and systems for managing transactions between two or more parties, in which at least one of the parties must fulfill certain obligations. More specifically, the invention relates to managing transactions, in which one or more of these obligations have not been completely or partially fulfilled.

### DESCRIPTION OF THE RELATED ART

There exist many types of transactions whereby one or more of the parties to a transaction must fulfill certain obligations according to specified terms in order for the transaction to be completed. Often these types of transactions are related to business.

A business transaction may be defined as any business-related exchange that comprises certain obligations of the parties which may be defined by a contract or agreement between the parties, or which may be commonly understood to involve certain obligations. One example of such a business transaction is the sale of goods or services. In a common business transaction involving the sale of goods or services, one party agrees to provide goods or services in exchange for payment. The party agreeing to provide the goods or services typically has an obligation to delivery goods or services that are not defective within a reasonable or stated time period. The recipient of the goods or services typically has an obligation to pay for the goods or services within a given period. The specific terms of the business transaction, such as quantity or date of payment, may be agreed upon orally, stated in writing, or dictated by common practice or prevailing law.

In business transactions, it is very common that one or more of the parties to the transaction does not completely or partially fulfill one of the obligations according to the terms of an agreement or contract. For example, parties to such a contract frequently do not pay, only partially pay, or even overpay an invoice. Such failures to perform according to the terms of a business transaction may be caused by errors in the underlying contract or may occur because the situation has changed since the contract was negotiated. Nonetheless, these failures to perform can lead to disputes between the parties and disrupt a business relationship.

One conventional method of resolving a dispute, such as underpaid or unpaid invoices, is to automatically generate a reminder or a demand for correction and send it manually or automatically to the customer. However, sometimes the problem cannot be solved merely by automatic reminders. In many cases, the unsatisfied party may first need to determine why the other party is not fulfilling its obligations. In this case, it would be advantageous to have access to all relevant information. Collecting the necessary information, however, has conventionally been a manual process involving a lot of paper work.

Furthermore, using conventional methods, companies frequently waste a lot of time and resources investigating such disputes. Because employees are frequently geographically dispersed throughout the company and the world, companies sometimes duplicate efforts by having more than one department investigating the same dispute or aspect of the dispute. This duplication of effort frequently results in lots of documents and, consequently, increased distribution costs. Furthermore, with each manual generation of a report, important data relating to the underlying business transaction may be dropped or unintentionally modified. Frequently, rather than expend the time and resources to investigate the dispute, many companies simply resort to closing the transaction without fulfillment of the unfulfilled obligation. In the case of a dispute related to underpayment, for example, companies frequently just write off the unpaid balance. Thus, there is a need for a method providing a more efficient solution of the problems described above.

### SUMMARY OF THE INVENTION

In accordance with the invention, as embodied and broadly described herein, methods and systems consistent with the principles of the invention provide for processing a business transaction between at least two parties, the method comprising the steps of: receiving transaction information identifying a business transaction comprising one or more obligations owed by at least one of the at least two parties to the other parties; receiving dispute information indicating that at least one of the one or more obligations of the business transaction has not been fully satisfied; creating a data object comprising some or all of the transaction information and the dispute information; and transmitting the data object to a dispute resolution entity for resolution.

### BRIEF DESCRIPTION OF THE DRAWINGS

The accompanying drawings, which are incorporated in and constitute a part of this specification, illustrate embodiments of the invention and, together with the description, explain the principles of the invention. In the drawings,

FIG. 1 illustrates the step of a method consistent with the principles of the present invention.

FIG. 2 is a block diagram of a computer system suitable for implementing the principles of the present invention.

### DESCRIPTION OF THE EMBODIMENTS

Reference will now be made in detail to exemplary implementations and embodiments of the invention, examples of which are illustrated in the accompanying drawings. Wherever possible, the same reference numbers will be used throughout the drawings to refer to the same or like parts.

The present invention provides methods and systems for resolving disputes that arise when a party to a business transaction does not fulfill one or more obligations related to the business transaction according to the terms of a related agreement or contract. The failure of any party to a business transaction to wholly or partially fulfill obligations related to the business transaction will be referred to herein as a “dispute.” Disputes may also arise when any of the parties to a business transaction gives notice to the other parties that the party does not intend to fulfill its obligations or questions its obligations under the agreement. For example, a dispute may arise when a company returns what it considers a defective product and questions its obligation to pay for defective goods. The process of resolving such disputes is referred to herein as the “Dispute Management Process” (DMP).

Methods and systems consistent with the present invention may be implemented using a computer system comprising one or more conventional computers which may be interconnected in the form of a computer network such as, for example, a company's internal network. In addition, one or more of the network computers may have access to the Internet or to other external networks, such as the networks of customers or service providers. In one embodiment of the present invention, a computer system consistent with the present invention comprises a data base management system (DBMS), in which information relating to the respective business transactions between the company and its customers and service providers may be stored.

In methods and systems consistent with the present invention, business transactions are stored electronically in a computer system and the failure of any party to fulfill obligations related to a business transaction may be electronically identified. For example, when a bank statement is electronically received from a company's financial institution, whether imported via a network connection or hardware device such as a floppy disk or CD-ROM, a computer program may automatically identify instances where an invoice was underpaid.

In certain embodiments of the invention, a DMP consistent with the present invention may be initiated upon the manual entry into the system of information related to a dispute. As would be obvious to one skilled in the computer arts, such information may be entered by, for example, using input devices operatively connected to any network computer or through a internet portal.

Once a dispute is identified, a DMP consistent with the present invention may be triggered automatically. According to the present invention, relevant information relating to the related business transaction (such as customer, payment, invoice or shipment information and related terms) may be determined from the data stored in the computer system. In certain embodiments, the relevant information may be determined automatically from data stored in a DBMS.

Upon automatic initiation of a DMP consistent with the present invention, a new data object may be created automatically with all or part of the information related to the dispute. The data object may, for example, comprise one or more files or tables, in which textual or numerical data relating to the business transaction is stored. In one embodiment, the information related to the dispute is copied from the DBMS into the data object. In another embodiment, the data object comprises links and pointers to relevant data in a database or the DBMS. One advantage of this method is that a user who receives the references to the storage locations can directly change the data in the DBMS. In yet another example, data objects may be created using a combination of the prior examples.

The data object may be transmitted electronically to one or more recipients, such as persons or parties responsible for the business transaction in question or, alternatively, those responsible for resolving disputes. The data object may be transmitted, for example, by storing the data object on a storage device of the respective computer of the receiving party or person. The recipients may then access the data object and display information from the data object on a display device or output the information to an output device, such as a printer. The data object may comprise all the relevant information as described above or only a pre-selected part of said data. The data object may also be transmitted to recipients by, for example, storing the data object to a location in the computer network or DBMS to which one or more users have access and then sending a message to the recipients indicating that a data object has been created at the respective location and is ready to be received.

In one embodiment consistent with the present invention, a first “reason code” that indicates the type of failure of the business process is associated with the data object. The first reason code may be added to the data object manually, such as a recipient of the data object, or automatically by the DMP. The reason code may be determined automatically by, for example, comparing information related to the dispute to entries in a table. In another embodiment, the reason code may be determined automatically based on rules and rule-based processing.

In one embodiment consistent with the present invention, a second “status code” that describes the status of the processing of the dispute may be associated with the data object. The status code may be implemented, for example, by adding a variable to the data object, the content of indicates the processing status. The assignment of the status code to the specific reason can be implemented, for example, by means of a table.

In certain embodiments, the data object may be associated with certain administrative information such as, for example, an ID and a creation time, a responsible person, a first and/or second caseworker. Again, these associations can, for example, be implemented by adding corresponding variables to the data object or linking or pointing to the data in a database or DBMS.

In certain embodiments of the present invention, the creation of a new data object comprising copies of the data of the business transaction is insofar advantageous, as the data object is independent of the business transaction object itself and can be the carrier of all life cycle information of the business transaction.

In certain embodiments of the present invention, the information relating to the business transaction and the data object are linked via an interface such that an update of the information of one automatically results in the update of the information of the other. This interface may be implemented, for example, by means of a table stored in the computer system, computer memory, or DBMS.

During the DMP, the status and reason code of the data object can be modified to reflect changes in the related business transaction. Additional information received during the DMP may also be associated with the data object. These status changes can be performed automatically by, for example, calling the interface. Additionally or alternatively, an indication of such change may also be associated with the data object.

In embodiments of a DMP consistent with the present invention, every step of a DMP may be automated such that each step may, in turn, trigger other actions. For example, if a reason code changes, the data object may be redirected to the recipient responsible for handling disputes related to the new reason code. Or, in another example, if an expected action does not take place within a certain period of time, a request for additional information may be created and transmitted to a customer. Such automatic actions may be implemented by, for example, using automatic queries of the respective variables.

The termination or completion of the DMP may be indicated automatically or manually by setting the status code to, for example, “closed.” In addition, the termination or completion of the DMP may be associated with a resulting or additional action, such as, for example, providing instructions to another system or entity to write off of a deducted amount to the responsible cost center. The data object can then be deleted or archived.

All information related to or generated as a result of the DMP, as well as any changes, can be made available for analysis by storing copies of the data object after each change or, for example, periodically. The data associated with the archived data objects may be used, for example, to optimize the future processing of related business transactions, prevent similar disputes, and optimize future processing of related disputes.

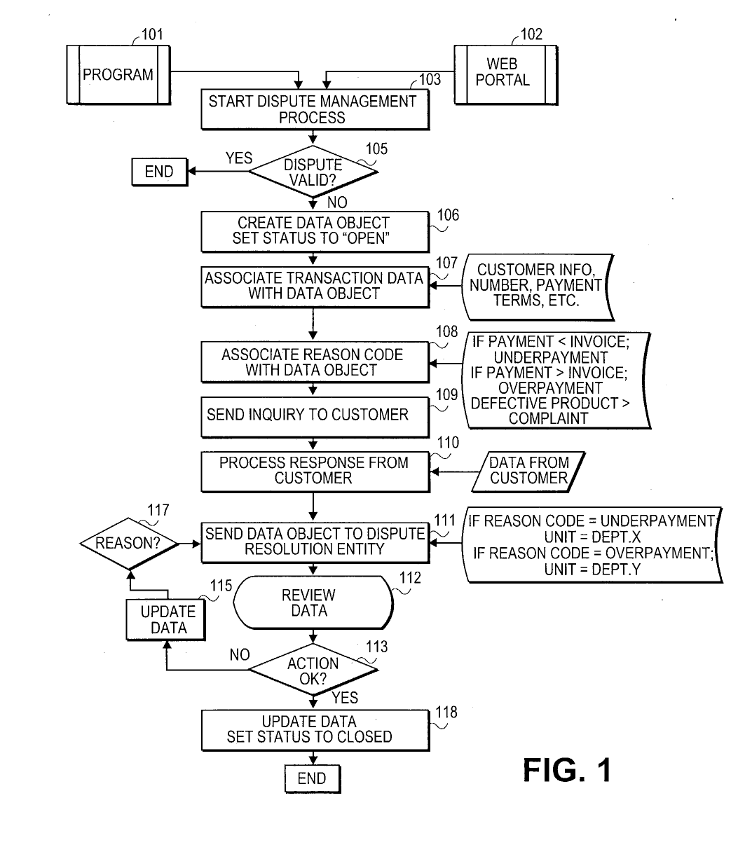

The invention is now described in more detail with reference to FIG. 1, which illustrates an exemplary embodiment of the present invention.

In this example, Program 301 may identify a dispute and transmit data related to the dispute to a program or system performing the steps of a DMP, hereinafter referred to as the “DMP system.” Alternatively, as described above, Program 301 may store data related to the transaction to a specified location and notify the DMP system that the information is available. Program 301 may be, for example, an accounting program that automatically identifies invoices that are overpaid or underpaid. In certain embodiments, a user may manually enter data related to a dispute via a network computer or Internet portal 302.

A DMP consistent with the present invention may be initiated by, for example, receipt of information related to a dispute from either Program 301, a network computer or Internet portal 302 (step 103).

As a first optional step, the DMP system may check to see if the dispute is valid. For example, in the case of an underpayment, the DMP system may compare the payment information to a payment protocol to see if payment has been performed according to the payment protocol. Particularly in the case of disputes manually entered via Internet portal 302, the DMP system may perform additional checks between the data that was manually entered and the data in the DBMS.

If the dispute is determined to not be valid, the DMP system terminates. If the dispute was manually entered via, for example, Internet portal 302, the DMP system may optionally send a message to the user indicating that the dispute is not valid and providing information as to why the dispute has not been processed as requested.

If the dispute is valid, a data object representing the dispute is automatically created (step 106). The data object may be associated with a status code that indicates the dispute is “open.” The data object is further associated with data related to the business transaction in question (step 107). The type of data associated with the data object may depend on the type of the business transaction. For example, if the business transaction that gave raise to the dispute is a sale of goods, the type of data associated with the data object may include such information as customer information, invoice number, payment terms, and billing parameters. This data may be obtained by the DMP system from the DBMS, if available.

The data object may be associated with a first “reason code” indicating the reason for the dispute (step 108). For example, the reason code may be set to “underpayment,” if the partner has not paid an invoice completely, or to “overpayment,” if the partner has paid more than the sum on the invoice. If, for example, a customer makes a complaint about a defective product, the reason code may be set to “complaint.”

The DMP system may optionally send an inquiry to the customer (step 109). The inquiry may contain, for example, a request for more information, acknowledgement that a complaint has been filed by the customer, or notice that a dispute has been initiated. The inquiry may be, for example, an email or fax that is automatically generated and, for example, populated using standard text associated with each reason code.

If a response is received from the customer, information associated with the response may be determined and associated with the data object (step 110). For example, the email address and the response of the customer may be stored verbatim or, in certain embodiments, the content of an email or electronically stored fax may be processed to determine whether it contains information responsive to the request.

The data object is sent to a dispute resolution entity for further processing (step 111). The dispute resolution entity may be, for example, a specific department of a company, a dispute resolution processing center outside the company, an individual, or other suitable entity. The dispute resolution entity to which the data object is transmitted may depend on the reason code or other variables, such as the dollar value of the transaction. For example, in the case of an underpayment or overpayment, the data object may be transmitted to department X; in the case of a complaint, it may be transmitted to a different department, Y.

The dispute resolution entity to which the data object is transmitted may be determined, for example, by use of a table. Optionally, the data object may be transmitted further to an individual within the dispute resolution entity, such as an account manager. This further routing may also be determined by, for example, a table.

In step 112, all or part of the information of the data object may be reviewed by the dispute resolution entity. The data associated with the data object may be displayed, for example, on a screen of computer 102 of an account manager or other dispute resolution entity responsible for processing the dispute. This dispute resolution entity can then trigger the appropriate action, such as, for example, the posting of a credit memo for the deducted amount to close the dispute process.

In step 113, the DMP system optionally checks to see whether the action taken is appropriate. If appropriate, the system data is updated, the status is set to closed (step 118) and the DMP ends.

If an error is detected or if it is detected that the dispute requires further action, the system updates the data received during the DMP (step 115). Depending on the reason for the dispute or the needed further action (step 116), the DMP system may return to step 109 and send an email (or an other kind of inquiry) to the customer asking for additional information. Alternatively, the data object may be returned to the dispute resolution entity for additional processing (step 111).

After one or more iterations of steps 309-316, the DMP system determines that the dispute has been resolved. The dispute may be resolved in the current example by, for example, payment of the remaining balance or determination that the remaining amount is not owed because a credit was justified. The system data may be updated and the status code may be set to indicate conclusion of the DMP by, for example, associating a “closed” code with the data object (step 118).

Upon conclusion of a DMP, or even at any point in the DMP, the DMP system may automatically send notices, such as by email or other means, to the customer or dispute originator with a status of the dispute resolution. The conclusion of the DMP may also trigger automatic notices to other departments within the company such as, for example, a message to an internal department to write off a certain amount.

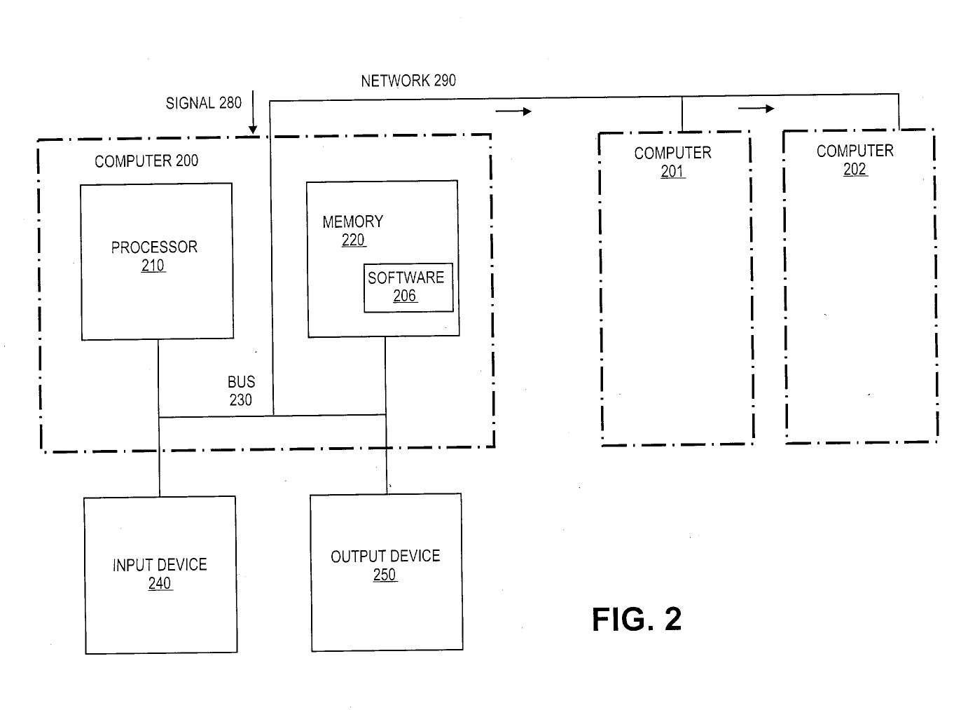

FIG. 2 depicts an exemplary block diagram of a system suitable for implementing the principles of the present invention. In certain embodiments, a system consistent with the present invention may be a computer 200, input device 240, and output device 250. In other embodiments, as shown in FIG. 2, an exemplary computer system may comprise a network of computers 200, 201, 202 (or 20q, with q=0 . . . Q-1, Q any number), some or all of which are operatively connected via a network 290.

As shown in FIG. 2, computer 200 comprises conventional components including memory 220 and processor 210. Computers 201, 202, . . . 20q may comprise many or all of the elements described below with respect to computer 200.

Computer 200 comprises processor 210, memory 220, bus 230, and, optionally, input device 240 and output device 250 (also called I/O devices). Computer 200 may be, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or the like. Processor 210 may be any processor suitable for the execution of a computer program including both general and special purpose microprocessors, and any one or more processors of any kind of digital computer. Processor 210 may be, for example, a central processing unit (CPU), a micro-controller unit (MCU), digital signal processor (DSP), or the like.

Memory 220 symbolizes elements that temporarily or permanently store data and instructions. Although memory 220 is illustrated as part of computer 200, memory 220 can also be integrated elsewhere in network 290, in computers 201, 202, . . . 20q and in processor 210 itself (e.g., cache, register), or elsewhere. Memory 220 can be a read only memory (ROM), a random access memory (RAM), or a memory with other access options. Memory 220 may be physically implemented by computer-readable media, such as, for example: (a) magnetic media, like a hard disk, a floppy disk, or other magnetic disk, a tape, a cassette tape; (b) optical media, like optical disk (CD-ROM, digital versatile disk—DVD); (c) semiconductor media, like DRAM, SRAM, EPROM, EEPROM, memory stick, or by any other media, like paper.

Optionally, memory 220 may be distributed across different media. Portions of memory 220 can be removable or non-removable. For reading from media and for writing in media, computer 200 uses devices well known in the art such as, for example, disk drives and tape drives. Memory 220 stores support modules such as, for example, a basic input output system (BIOS), an operating system (OS), a program library, a compiler, an interpreter, and a text-processing tool. Support modules are commercially available and can be installed on computer 200 by those of skill in the art. For simplicity, these modules are not illustrated.

Memory 220 also stores software 206. Software 206 may include a data base management system application for the loading and storing of data relating to the business transactions as mentioned above. Software 206 may also include instructions for interpreting the data and processing it in a manner consistent with the principles of the present invention. Although software 206 is illustrated as being stored in memory 220, software 206 can be located elsewhere, such as embodied on a carrier wave or stored on a computer readable medium.

Input device 240 may be any conventional input device that provides data and instructions for processing by computer 200. For example, input device 240 may be a keyboard, a pointing device (e.g., mouse, trackball, cursor direction keys), microphone, joystick, game pad, scanner, disk drive. Input device 240 may also be, for example, a wireless receiver (e.g., a satellite dish or terrestrial antenna), a sensor (e.g., a thermometer), or a counter (e.g., goods counter in a factory).

Output device 250 may be any conventional output device that outputs instructions and data that have been processed to the user. Conventional output devices include, for example, a cathode ray tube (CRT), flat panel display, liquid crystal display (LCD), speaker, printer, plotter, or vibration alert device. Output device 250 communicates with the user, but it can also communicate with other computers.

Input device 240 and output device 250 can be combined in a single I/O device. Additionally, other kinds of input or output devices can be used to allow interaction with a user as well. For example, feedback provided to the user can be any form of sensory feedback, such as visual feedback, auditory feedback, or haptic feedback; and input from the user can be received in any form, including acoustic, speech, or haptic input.

Bus 230 and network 290 provide logical and physical connections by conveying instruction and data signals. While connections inside computer 200 are conveniently referred to as “bus 230,” connections between computers 200-20n are referred to as “network 290.” Optionally, network 290 comprises gateways or computers that specialize in data transmission and protocol conversion.

Networking environments are commonplace in offices, enterprise-wide computer networks, intranets and the internet. The physical distance between a remote computer and computer 200 is often not important; that is, network 290 may be a wired or a wireless network.

The present invention can be implemented in digital electronic circuitry, or in computer hardware, firmware, software, or in combinations thereof. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Method steps of the invention can be performed by one or more programmable processors executing a computer program to perform functions of the invention by operating on input data and generating output.

Generally, a computer will also include, or be operatively coupled to receive data from or transfer data to, or both, one or more devices for storing data, e.g., magnetic, magneto-optical disks, or optical disks. Information carriers suitable for embodying computer program instructions and data include all forms of non-volatile memory including, by way of example, semiconductor memory devices, such as EPROM, EEPROM, and flash memory devices; magnetic disks such as internal hard disks and removable disks; magneto-optical disks; and CD-ROM and DVD-ROM disks. Additionally, the processor and the memory can be supplemented by, or incorporated in, ASICs (application-specific integrated circuits).

The foregoing description of an implementation of the invention has been presented for purposes of illustration and description. It is not exhaustive and not intended to limit the invention to the precise form disclosed. Modifications and variations are possible in light of the above teachings or may be acquired from the practicing of the invention.

It is intended that the specification and examples be considered as exemplary only, with a true scope and spirit of the invention being indicated by the following claims.

What is claimed is:

1. A computer-implemented method for processing a business transaction between at least two parties, the method comprising the steps of:
receiving transaction information identifying a business transaction comprising one or more obligations owed by at least one of the at least two parties to the other parties;
receiving dispute information indicating that at least one of the one or more obligations of the business transaction has not been fulfilled;
creating a data object comprising some or all of the transaction information and the dispute information; and
transmitting the data object to a dispute resolution entity for resolution.

2. The method of claim 1, further comprising:
determining a first code representing information that describes how the one or more obligations have not been fulfilled; and
associating the first code with the data object.

3. The method of claim 2, wherein the first code is determined automatically by means of a table.

4. The method of claim 2, further comprising:
selecting the dispute resolution entity to which the data object is transmitted based on the first code.

5. The method of claim 2, further comprising:
determining a second code representing the status of processing of the data object; and
associating the second code with the data object.

6. The method of claim 5, further comprising:
selecting the dispute resolution entity to which the data object is transmitted based on the first or second code.

7. The method of claim 4, further comprising:
obtaining resolution information indicating a first action to be taken to resolve the dispute;
initiating the first action;
determining if the at least one of the one or more obligations has been fulfilled; and
modifying the second code to indicate that the status of the processing of the data object.

8. The method of claim 7, further comprising:
initiating a second action depending on the first or second code.

9. The method of claim 1, further comprising:
determining that additional dispute or transaction information is needed; and
automatically querying one or more of the parties for additional dispute or transaction information.

10. A system for automatically processing a business transaction between at least two parties, the system comprising:
at least one memory having program instructions to execute at least one program component; and
at least one processor to execute the program instructions to perform operations comprising:
receiving transaction information identifying a business transaction comprising one or more obligations owed by at least one of the at least two parties to the other parties;
receiving dispute information indicating that at least one of the one or more obligations of the business transaction has not been fulfilled;
creating a data object comprising some or all of the transaction information and the dispute information; and
transmitting the data object to a dispute resolution entity for resolution.

11. The system of claim 10, wherein the operations performed by the processor further comprise:
determining a first code representing information that describes how the one or more obligations have not been fulfilled; and
associating the first code with the data object.

12. The system of claim 11, wherein the first code is determined automatically by means of a table.

13. The system of claim 11, further comprising:
selecting the dispute resolution entity to which the data object is transmitted based on the first code.

14. The system of claim 11, wherein the operations performed by the processor further comprise:
, further comprising:

15. determining a second code representing the status of processing of the data object; and
associating the second code with the data object.

16. The method of claim 14, further comprising:
selecting the dispute resolution entity to which the data object is transmitted based on the first or second code.

17. The method of claim 13, further comprising:
obtaining resolution information indicating a first action to be taken to resolve the dispute;
initiating the first action;
determining if the at least one of the one or more obligations has been fulfilled; and
modifying the second code to indicate that the status of the processing of the data object.

18. The system of claim 14, wherein the operations performed by the processor further comprise:
initiating a second action depending on the first or second code.

19. The system of claim 10, wherein the operations performed by the processor further comprise:
determining that additional dispute or transaction information is needed; and
automatically querying one or more of the parties for additional dispute or transaction information.

19. A computer-readable medium containing instructions for controlling a computer system, operating at least one application, to perform a method comprising:
receiving transaction information identifying a business transaction comprising one or more obligations owed by at least one of the at least two parties to the other parties;
receiving dispute information indicating that at least one of the one or more obligations of the business transaction has not been fulfilled;
creating a data object comprising some or all of the transaction information and the dispute information; and
transmitting the data object to a dispute resolution entity for resolution.
